(19) United States
(12) Patent Application Publication
(10) Pub. No.: US 2005/0049916 A1
(43) Pub. Date: Mar. 3, 2005

(54) Method and system for facilitating client driven customer and employee performance improvement promotions

(76) Inventor: Barry Tracht, Pompano Beach, FL (US)

Correspondence Address: David P. Lhota, Suite 1900, 200 East Broward Boulevard, Fort Lauderdale, FL, 33301, US

(21) Appl. No.: 10/653,579

(22) Filed: Sep. 2, 2003

(51) Int. Cl. G06F 17/60

(52) U.S. Cl. 705/14

(57) ABSTRACT

A system and method for facilitating client driven customer and employee performance enhancement promotions that provides access codes to customers, employees and, or vendors meeting certain criteria enabling them to visit a secured area of a globally accessible web site having at least one game of chance or other user-initiated activity that yields random results and immediately communicates winning or non-winning status after the participant plays the game, wherein the codes may comprise unique codes or passwords or a global code or password and are distributed with products or services, in random drawings, advertisements, mail, e-mail, over the Internet, by telephone or directly to customers, employees and, or vendors meeting identified milestones and wherein the games comprise computer processed point-and-click games. The system and method of the instant invention may employ client customized methods for providing access codes and client customized user initiated activities that correspond with the client's company, product and, or service practices and image. The system and method comprises a plurality of unique codes readable by a computer processor for gaining access to at least one user initiated activity or game of chance in a secured area of a web site, at least one URL address having a web site and at least one medium or channel of distribution for providing the unique codes to recipients based on at least one purchase or satisfaction of at least one predetermined milestone.

### CROSS REFERENCE TO RELATED APPLICATIONS

N/A

### STATEMENT REGARDING FEDERALLY SPONSORED RESEARCH OR DEVELOPMENT

N/A

### COPYRIGHT NOTICE

A portion of the disclosure of this patent document contains material that is subject to copyright protection. The copyright owner has no objection to the facsimile reproduction by anyone of the patent document or patent disclosure as it appears in the Patent and Trademark Office patent file or records, but otherwise reserves all copyrights rights whatsoever.

### BACKGROUND OF THE INVENTION

1. Field of the Invention

This invention generally relates to company promotions and incentive programs, and more particularly, to a performance improvement and loyalty improvement promotional system and process that provides selective access to “instant win” games and, or other user interactive promotional events on a globally accessible computer network in a manner designed to promote a company's and, or sponsor's product(s) and, or service(s) while enhancing the company, product or service image to improve and, or cultivate customer, employee and, or vendor performance improvement and loyalty.

2. Description of Related Art

Consumer, employee and trade directed promotions are common methods employed to market companies, products and services. Common promotions include sweepstakes, games of skills, contests, gifts, coupon programs, gift certificates, prize point accumulation incentive programs and redemptions, and rebates. Promotions attract attention to a company and its products or services, and can be used to enhance and influence customer sales and continued buying loyalty. Although promotions are typically directed to consumers, they may also be used to promote a company to vendors and employees in a manner that improves sales performance and loyalty. Certain promotions known in the art, such as sweepstakes, games of skill, and contests, are more popular than others but are less effective because they are stale and, or have limited appeal. Accordingly, companies are always looking for unique ways to promote the company and its products and, or services and to enhance customer, employee and vendor sales performance and continued buying loyalty through incentive programs or promotions.

With the Internet, there are new opportunities for conducting new and old promotions. Although the Internet provides a new medium for offering old promotions, such as sweepstakes and games of skill, these known promotions carry the same drawbacks. For instance, Internet-based sweepstakes still comprise a drawing of random numbers, lack consumer interaction or choice of selections, only give a consumer one reason to participate and often fail to make a lasting impression. Due to the fact there is no opportunity for an instant win, promotions offering opportunities to play games of skill lack mass appeal and only benefit a small cross section of skillful participants. Many consumers do not have the time, interest or expertise to engage in games of skill. Promotions that would give participants more then one reason to visit a web site and provide interaction while maintaining mass appeal would be well received, especially if it could immediately notify participants of winning or non-winning status. However, there are no promotion methods known that adequately address this need.

The internet-based promotions known in the art include sweepstakes and games of skill. U.S. Pat. No. 6,173,267, issued to Cairns, discloses an Internet-based sweepstakes promotion wherein a customer receives a unique sweepstakes code and a URL address to a designated web site through the purchase of a product. The purchaser visits the website, enters the sweepstakes code and is informed as to whether the code is a winner, i.e. whether it matches the winning sweepstakes number. Cairns' method is described as an Internet-based sweepstakes wherein the unique code directly determines the winning or non-winning status. However, there is no participant interaction as the winning number is predetermined and merely compared to the sweepstakes number entered by the participant. The Cairns' method describes a drawing and gives the consumer no other reason to gain additional access to the web site except to see if they have the winning code. U.S. Pat. No. 6,267,672, issued to Vance, discloses an Internet-based promotion that provides an access code to a designated Internet address, which the consumer uses to access and participate in a game of skill. Vance discloses limiting the time the consumer can play the game and requires the consumer to achieve certain skill levels. The Vance method is premised on enticing consumers to buy additional products for additional opportunities to overcome the challenge of the game and to improve their skill in playing the game. Accordingly, Vance is limited to skillful participants and participants interested in enhancing the skill. These references to do not disclose a system and method for facilitating client driven customer and, or employee performance enhancement promotions that provide instant win games of chance based on participant interaction, rather than games of skill, and offer more than a sweepstakes drawing.

As the prior art fails to disclose a method for Internet-based promotions that provide participant interaction beyond a sweepstakes while maintaining appeal to the general public, as contemplated by the instant invention, there exist a need for the instant invention. The instant invention addresses this need by providing a system and method for promoting companies, products or services that can be directed to an audience that extends beyond consumers, entices participants to purchase additional products or services, qualify for rebates or to adjust their behavior to seek additional opportunities to play an instant win game of chance or to engage in another type of user initiated activity. The instant invention addresses the need for a promotional system and method that incorporates user initiated activities having mass appeal regardless of skill.

### BRIEF SUMMARY OF THE INVENTION

In light of the foregoing, it is an object of the present invention to provide a system and method for facilitating client driven customer and employee performance improvement promotions that are user interactive and adapted for mass appeal without regard to specialized to skills.

It is another object of the instant invention to provide a promotional system and method that promotes company buying loyalty to improve employee and customer sales performance.

It is an additional object of the instant invention to provide a promotional system and method that promotes customer and employee buying loyalty by providing limited access to instant win games of chance.

It is a further object of the instant invention to provide a promotional system and method that promotes company buying loyalty and improves employee and customer sales performance by providing access to games or other user initiated activities on a secured Internet location based on performance and, or purchases.

It is another object of the instant invention to provide a promotional system and method that provides access to games or other user initiated activities based on non-performance criteria whereby the game or games are used to promote the company brand or image or provide a method or system for qualifying.

It is also an object of the instant invention to provide a company promotional system and method for promoting employee and customer purchasing loyalty and performance by distributing access codes with company products or services and, or to recipients, such as employees.

It is another object of the instant invention to provide a company promotional system and method for promoting employee and customer purchasing loyalty and sales performance that can distribute access codes in a variety of ways and, or with a variety of mediums, such as in packaging, mailings, on card inserts in advertisements, on game pieces, in drawings, by Internet, by electronic mail, or by telephone.

In light of these and other objects, the instant invention comprises a system and method for facilitating client driven customer and employee performance enhancement promotions that provides access codes to customers, employees and, or vendors, enabling them to visit a secured web site or secured area of a globally accessible web site having at least one instant win game of chance or other user-initiated activity that yields random results and virtually immediately communicates winning or non-winning status. The codes may comprise unique codes or passwords or a global code or password and are distributed with a variety of methods, such as with a purchased product or service, in a random drawing, via an advertisement, mailings, over the Internet, by e-mail, by telephone or directly to customers, employees and, or vendors meeting identified milestones. Unique and global access codes are generally referenced herein as access codes. The system and method of the instant invention may employ client customized methods for providing access codes and client customized user initiated activities that correspond with the client's company, product and, or service practices and image. In the preferred embodiment, the instant invention comprises a plurality of unique codes readable by a computer processor for gaining access to at least one user initiated activity, game of chance or instant win game in a secured area of a web site, at least one URL address having a web site, at least one medium or channel of distribution for providing the unique codes to recipients, such as customers and employees.

The instant invention further comprises a method for promoting a company and, or its products and, or services by providing an access code through a variety of methods including a purchase or advertisement wherein a valid/authentic code provides access to a secured web site location and the right to play an instant win game of chance or other user initiated activity residing at the secured area of the website a predetermined number of times, receiving and validating the unique code, providing at least one “instant win” game, game of chance or other user-initiated activity at the secured web site area, monitoring and controlling the authorized number of plays, determining winning (or non-winning) status, communicating status to recipients/participants, redeeming at least one prize, rebate, redemption prize points or similar offering based on a win, instructing the recipient/participant on the next step(s) based on their status, verifying eligibility and winning status based on a review of original version of unique code, if required, and maintaining and updating records. The instant invention also selectively requests, receives, stores and, or utilizes recipient/participant related information for future communications, research and promotions.

Recipient and participant refer to a person that receives and uses a valid code to participate in the promotion and typically could comprise a potential or existing customer, employee or vendor. The terminology “instant win game of chance” is used to identify games or activities that do not require or necessitate a particular skill but require an authorized user initiated action or actions or input to activate the game or activity, such as pressing, clicking or otherwise actuating at least one or more hot spots on the web site from a variety of offered selections or choices or at least one designated keyboard key. For instance, one game may comprise an Internet version of a slot machine that requires the user to press or click a “Spin” hot spot to play the game. Another game may require one or more hot spot actuations to play the game, such as in an Internet version of the game marketed under “Wheel of Fortune,” whereby participants can click to spin the wheel, win various prizes and, or spell the word “fortune” or some other word to win the so-called grand prize jackpot. A user initiated activity may require the recipient/participant to select a racing icon in a computer-generated race or an answer to a multiple choice question.

In accordance with these and other objects, which will become apparent hereinafter, the instant invention will now be described with particular reference to the accompanying drawings.

### BRIEF DESCRIPTION OF THE SEVERAL VIEWS OF THE DRAWINGS

FIG. 1 is a block diagram view of the preferred embodiment of the system and method of the instant invention.

FIGS. 2A-2C are flow diagram views of the preferred embodiment of the system and method of the instant invention.

### DETAILED DESCRIPTION OF THE INVENTION

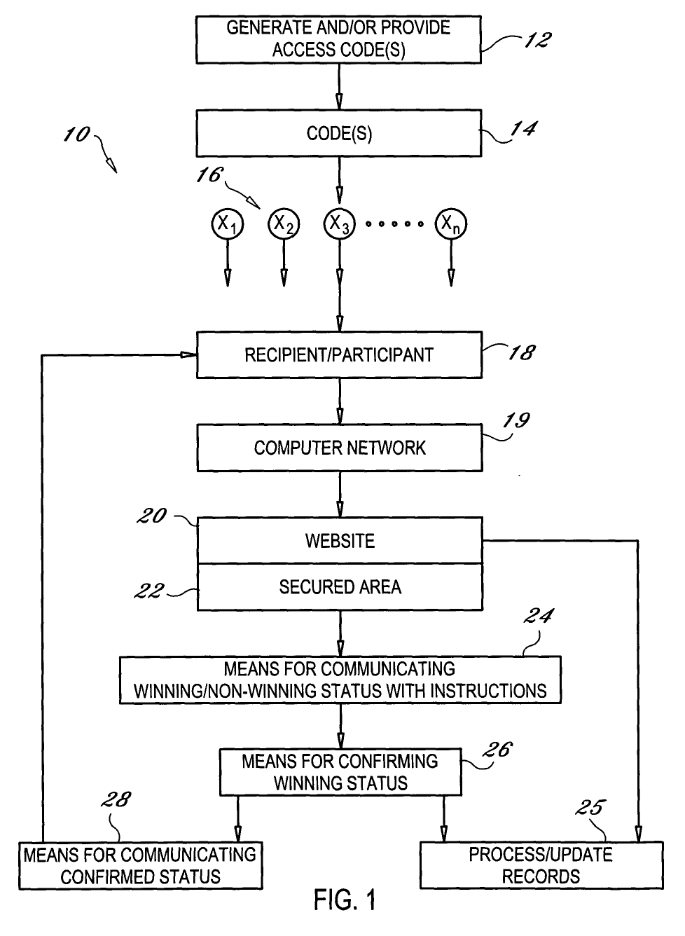

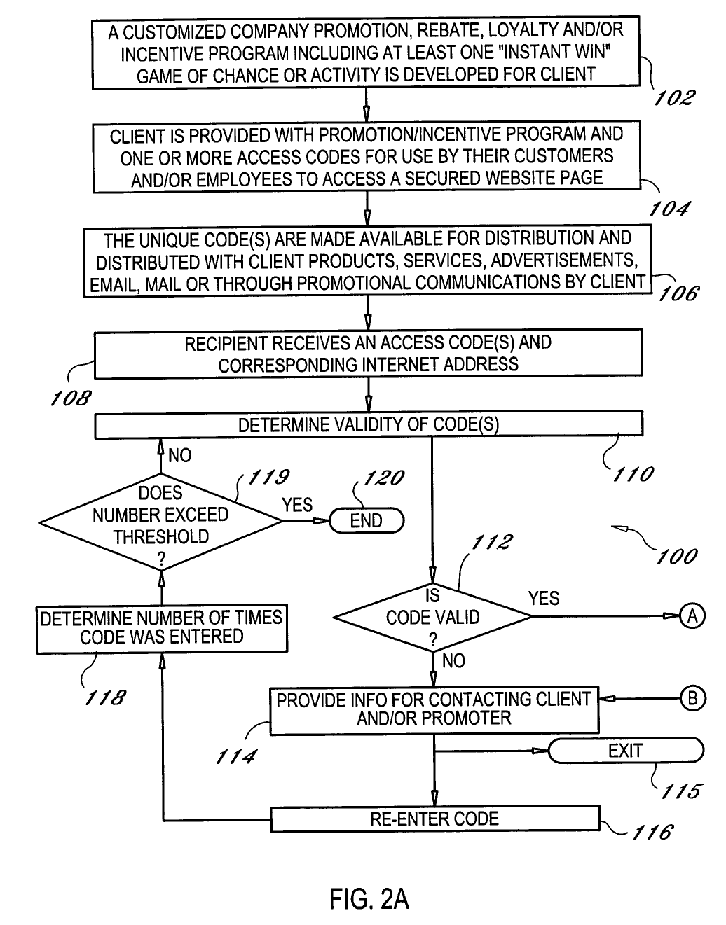

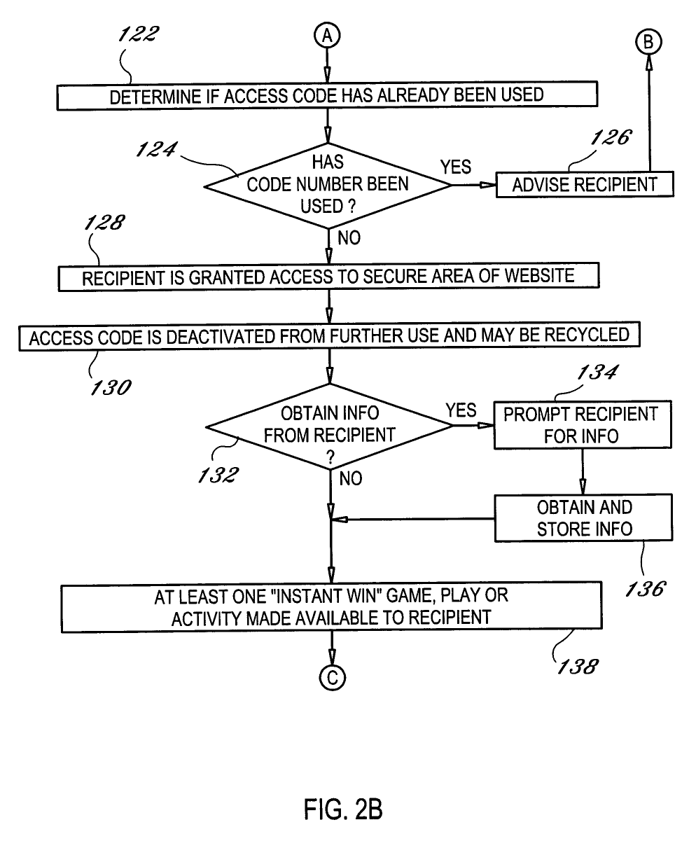

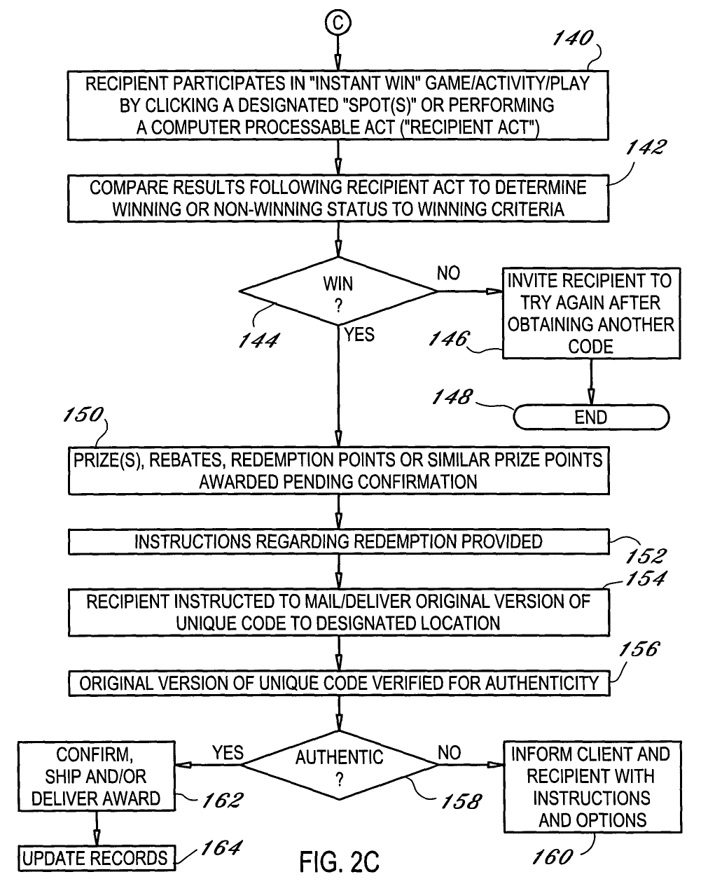

With reference to the drawings, FIGS. 1-2C depict the preferred embodiments of the instant invention which is generally referenced as a promotion system and, or method and, or by the numeric characters 10 and, or 100, respectively. With reference to FIGS. 1 and 2, the instant invention comprises a system 10 and process 100 for facilitating client/customer driven customer, employee and, or vendor performance improvement promotions/incentive programs and rebates that provide access codes with purchases, through e mail, or through advertisements or possibly based on other selected criteria to customers, employees and, or vendors for access to a secured website having at least one user-interactive activity having random results, instant win game of chance, wherein the access code enables the recipient/participant to participate at least once or a limited number of times. The invention 10, 100 is designed to be adaptable to a particular client, wherein a client comprises a company, sponsor or promoter utilizing the invention 10, 100. The instant invention 10, 100 confirms substantially immediately the winning or non-winning status pending confirmation, provides instructions for confirmation, confirms and communicates the status and processes and awards a prize, such as a product, service, cash, redemption points, prize points, rebates, etc. based on the confirmation. The instant invention 10, 100 is primarily software driven, such as by a computer processor, and includes a variety of software code(s) for operating, processing and, or facilitating the various features of the instant invention 10, 100, but also accommodates traditional communication processes for processing and confirming results.

With reference to FIG. 1, the system 10 comprises a means for generating and, or providing access code(s) 12, access codes 14, means for selectively distributing the access code(s) and at least one URL web site address 19 to customers, employees and, or vendors (such as in product packaging and, or advertisements, via sales, random drawings, over the Internet, e-mail, telephone, electronically) 16, URL address or similar network address, Internet or comparable network accessible web site 20 at the URL address being electronically secured or having a secured area 22 that requires a valid access code 14 for eligibility or access, at least one user interactive activity 23 such as an instant win game of chance, means for allowing and controlling recipient/participant 18 play, means for communicating winning/non-winning status 24, means for confirming winning status 26, means for communicating confirmed status to the corresponding recipient/participant 28 and, or means for processing and updating records related to the invention 10, 100 such as the customers, employees, and, or vendors 18, clients/customers and records regarding the activities, participants and results. The process 100, means for generating and, or providing access code(s) 12 and a URL address for the website 20/22, selectively distributing the access code(s) 16, Internet or comparable network accessible secured web site 20/22, the user-interactive activities and, or games 23, means for allowing and controlling recipient/participant 18 play, means for communicating winning/non-winning status 24, means for confirming winning status 26 or rebate eligibility, means for communicating confirmed status to the corresponding recipient/participant 28 and, or means for processing and updating records preferably comprises processor readable software.

The access codes 18 and web site 20/22 URL address are preferably distributed or communicated together. The access codes 14 preferably comprise a plurality of unique codes or passwords or a global code or password, but are generally referenced herein as access codes 18. The access codes 18 preferably comprise a string of identifiable characters that are readable by a computer processor, microprocessor or similar electronic means and may be distributed by a variety of modes and methods, such as with a purchased product or service or advertisement by mail, in a random drawing, over the Internet, by e mail, by telephone or directly to potential or existing customers, employees and, or vendors meeting identified milestones, as shown in FIG. 1. They may be provided to the recipient/participant 18 on a card, plastic paper, paper, chipboard, plastic, paper, molded game piece, booklet, etc., with, in or apart from the packaging or wrapping or advertisement, by mail and, or transmitted by known electronic methods, through a globally or locally accessible computer network, e mail, or verbally. The plurality of available code distribution methods 16 are illustrated in FIG. 1 by the notation 16X₁ to 16Xₙ. Access codes 18 and web site addresses may be provided through mail correspondences, on labels, on coupons, in advertisements, magazines or newspapers in print or as an insert, by e mail, or any other known communication means. They may be designed and distributed in a manner adapted to reach a particular group of people, such as based on location or interests, and, or in a manner that corresponds to the image of the client. In another embodiment, a recipient/participant 18 may be enrolled in the promotional process 100, either automatically by the client (company, sponsor or promoter) or through the action of the recipient/participant. In other embodiments, the web site address(es) and access codes 14 may be provided in an on-going promotional program or campaign as a one time password, id or code, in which there could be on-going visits to the site by the recipient for additional promotion participation or plays wherein the validity of the access code 14 is extended based on achieving stated levels of performance as a customer, employee or vendor.

Valid access codes 14 allow the recipient to log onto the web site 20/22. The access code 14 is entered at the website 20/22 and processed for determining authenticity and validity, such as by the operating software residing at the web site. If the access code 14 is authenticated, the recipient/participant 18 is authorized to play some form or type of promotional game or activity that randomly and immediately determines winners when receiving one or more inputs from the user. The access code 14 is therefore an authentication code that grants the opportunity to participate in or play the promotional game and does not determine or affect winning or non-winning status. The promotional games or activities 23 may include but are not limited to instant win games of chance, or other user-interactive activities that randomly determine winners or determine winner regardless of skill.

With reference to FIGS. 2A-2C, the process for facilitating client/customer driven potential or existing customer, employee and, or vendor performance enhancement promotions/incentive programs 100 generally comprises generating and, or providing 12 access codes 14 to customers, employees and, or vendors 18 meeting certain criteria 16 (102), such as making purchases or meeting sales milestones, enabling them to visit (via a locally or globally available network 19) a secured web site 20 or secured area 22 of a web site to play a limited number of times at least one available instant win game of chance or other user-initiated activity 23 that yields random results, determining validity of the code 112, granting access to the activities 23 to recipient/participants 18 having a valid access code 14 (128), facilitating and, or operating the instant win game of chance or other user-interactive activity 23 (138, 140), determining winning/non-winning status 142-148), awarding prize(s) pending confirmation 150 or possibly awarding the prize itself, verifying access code authenticity and winning status 156-162 and processing and updating records 164. With reference to FIG. 2A, the invention 10 may include developing a customized company, promotion, loyalty, rebate and, or incentive program having at least one user-interactive activity (102). The client is provided with the promotion/incentive program, a URL address hosting a secured web site 20/22 and one or more access codes 14 for use by their customers, employees and, or vendors to access the secured website or a secured area on the web site 20/22 (104). Access codes 14 and web site 20/22 information, such as the relevant URL address, are made available for communications and distribution and distributed in client products, via e mail, in advertisements, through mailings, with client services or through other promotional communications (106). The recipient receives an access code 14 with the web site address information, visits the web site 20 and enters the code 14 to gain access to a secured area 22 of the web site where at least one user interactive activity is available (108). The code 14 is then checked for authenticity and validity (112). If the code 14 is not valid then the recipient/participant 18 is provided information for contacting the client and, or promoter (114) and can re-enter the code in case there was an entry error (116). The code 14 may only be re-entered a limited number of times and is monitored to determine the number of re-entries and whether the number of re-entries exceeds a predetermined threshold (118, 119). Once the threshold is reached the program ends (120).

With reference to FIG. 2B, the program also determines whether the entered code 14 has already been used to access the secured area of the website and, or to engage in a user-interactive activity 23 (122-126). The program may alternatively determine when a code has been used a predetermined allotted number of times. If the code 14 has already been used the allotted number of times, then the recipient/participant is advised (126). If the code 14 is still available for use, then the recipient/participant 18 is granted access into the secured area 22 of the web site 20 (128). The code 14 is deactivated from further use once it has been used once or the allotted number of times (130). Codes 14 that have been deactivated may be recycled for future use (130). The system and method of the instant invention 10, 100 may also prompt the recipient/participant 18 for information, such as contact information, personal interests and purchasing habits, for creating a database of contact information and marketing profiles. The process 100 determines if the program 100 is configured for requesting and obtaining recipient/participant 18 information. If it is then the recipient/participant 18 is prompted for the desired information (134). The information obtained is stored in an accessible location, which is preferably a computer readable location such as a database. (136). Thereafter, at least one “instant win” game, game of chance or other user-interactive activity is activated and made available for use by the recipient/participant (138).

With reference to FIG. 2C, upon activation the recipient/participant 18 selects and, or is offered a game or activity. The games and, or activities are played by clicking or actuating at least one designated hot spot or performing some other processor readable act (“Recipient Act”) (140). The available user activities and, or games randomly determine winners so that they may be enjoyed by the masses without the need for special skills. The award for winning could be in the form of prizes, gift items, cash, rebates, travel, redemption points or similar prize points. The Recipient Act preferably comprises clicking at least one hot spot, highlighting at least one hot spot and pressing enter, or striking a particular key or series of keys (140). Following the Recipient Act, the process 100 compares the results to the pre-established winning criteria and determines whether the recipient/participant 18 is a winner or non-winner, i.e. winning status. If the status is non-winning, then the recipient/participant is invited to try again after obtaining another code and may be provided with additional information (146, 148). If the recipient/participant 18 is a winner, then the corresponding award is redeemed pending confirmation and the winner is given instructions (150-152). Winning information is transmitted on-line to a processing center. Winning status may be confirmed and activated when the recipient/participant 18 returns the original version of their access code to a designated location and it is confirmed to be authentic. The winner is instructed to mail or otherwise deliver the original version of the access code 14 to a designated location for authentication (154-156). If the original version of the code 14 is not deemed authentic, the recipient/participant is informed and given instructions and options. If the original version of the code 14 is deemed authentic, the recipient/participant is instructed and the award is shipped, delivered or made available for collecting or paying rebates (162). Thereafter, records are updated (164).

The user-interactive games and activities 23 may comprise an electronic slot machine type of game, random gift spots, gift spot matching and, or gift wheel. The slot machine type game requires actuation of one hot spot or keyboard key to randomly cycle a plurality of images, which must match a predetermined combination or number of selected number of images to win. In the lottery machine type of game the recipient/participant selects and, or inputs a plurality of numbers in a given range and then actuates the hot spot, which causes a plurality of number spots to randomly cycle through numbers in the number range until it randomly stops. A predetermined number of selected numbers, letters or images must match the winning results. Electronic poker involves selecting a predetermined number of electronic playing cards to achieve the best poker hand, which must be equal or better then the predetermined game hand to win. The random gift spots game requires the recipient/participant to actuate and match a predetermined number of hot spots to determine if they win a prize. Gift spot matching involves actuating a predetermined number of hot spots, which must result in a predetermined number of matches to win. The gift wheel is an electronic generated “Wheel of Fortune” type wheel that spins when a corresponding hot spot or key is actuated and when it stops reveals whether the recipient/participant won a prize. The instant invention may incorporate other random-based games and activities similar to those described.

The recipient/participant 18 may be required to provide personal information either prior to or after playing the game. Personal information may be useful to the company, sponsor, or promoter in establishing the demographics of the customer base of those who sign-on and, or have some affiliation to the company of sponsors product(s) and/or service(s). After playing or participating in the game, in almost all cases, depending on the type of promotional game and the sponsors criteria, the recipients will be immediately notified if they “have” or “have not” won and exactly “what” it is that they have won, pending confirmation. Winnings could be comprised of any type of merchandise product or products, prize “points” (could be called something other than “points”) for instant redemption points or on-going accumulation points for redemption at a later date, travel, cash, or any other type of award offering. The invention may include personal accounts for tracking points and, or awards. The promotion may also be structured for promotional product rebates, discounts, and coupons.

Based on the promotion parameters, and choice and levels of gifts available to a game winner, the winner may be offered the option of viewing and ordering their winning gift from a linked on-line gift catalog displaying a variety of gift choices within a specific category or level in which they have won. A winning recipient is notified and may be required to submit and present the original version of the winning password, id or code for verification of their winning eligibility. Upon authentication, the winning award would be fulfilled.

The instant invention has been shown and described herein in what is considered to be the most practical and preferred embodiment. It is recognized, however, that departures may be made therefrom within the scope of the invention and that obvious modifications will occur to a person skilled in the art.

1. A process for facilitating client driven potential or existing customer and, or employee sales improvement and loyalty promotions, said process comprising:
providing access information to at least one secured website page on a network accessible location for distribution in a promotion;
said access information including at least one unique access code;
determining whether said access code is authentic;
providing at least one game of chance at the website page;
allowing participants that input an authentic access code to play said at least one game a predetermined number of times; and
communicating to the participant whether the participant won said at least one game.

2. A process as recited in claim 1, further comprising:
conveying at least one predetermined winning to the participant if the participant wins said at least one game based on at least one predetermined parameter.

3. A process as recited in claim 2, wherein said award comprises a predetermined prize.

4. A process as recited in claim 2, wherein said award comprises a predetermined number of redemption points for possible ongoing accumulation and redemption.

5. A process as recited in claim 1, further comprising:
determining whether the participant won said at least one game based on predetermined parameters after the participant plays the game.

6. A process as recited in claim 2, wherein said game requires the participant to perform at least one inputting action after entering said authentic code to play said game.

7. A process as recited in claim 1, wherein said step of determining code authenticity comprises:
comparing a code entered to a predetermined valid code.

8. A process as recited in claim 1, wherein said step of determining code authenticity comprises:
forwarding the access code that participant entered at the website in its original version to a designated location.

9. A process as recited in claim 1, wherein said access code comprises a plurality of unique access codes.

10. A process as recited in claim 1, wherein said at least one game of chance comprises a plurality of games that each require at least one point-and-click action or computer key entry.

11. A process as recited in claim 1, wherein said game comprises an electronic game that requires actuation of at least one hot spot to randomly cycle a plurality of images wherein a predetermined number of said images must match to win.

12. A process as recited in claim 1, wherein said game comprises inputting a predetermined number of numbers in a predetermined range and actuating a hot spot to randomly cycle through the numbers in said range until it stops and requiring that a predetermined number said inputted numbers match a predetermined number combination.

13. A process as recited in claim 1, wherein said game comprises selecting a predetermined number of electronic playing cards and comparing the selected playing cards to a preselected combination of cards to determine winning or non-winning status.

14. A process as recited in claim 1, wherein said game comprises a plurality of random gift spots that require the actuation and matching of a predetermined number of hot spots to determine winning or non-winning status.

15. A process as recited in claim 1, wherein said game comprises actuating a predetermined number of hot spots which must result in a predetermined number of matches to win.

16. A process as recited in claim 1, wherein said game comprises an electronic generated game that cycles when a hot spot is actuated and reveals whether the participant won when it stops.

17. A process as recited in claim 1, wherein said game comprises an electronic generated game that cycles through a plurality of potential outcomes when at least one hot spot is actuated and reveals a winning status when stopping.

18. A process as recited in claim 1, wherein said game comprises an electronic generated selection of identifiable hot spots that facilitates the selection of at least one of said hot spots to reveal a winning status.

19. A system for facilitating client driven customer and, or employee improvement promotions, said system comprising:
means, comprising a set of processor readable code, for providing access information to at least one secured website page on a network accessible location for distribution in a promotion, said access information including at least one unique access code;
means, comprising a set of processor readable code, for determining whether said access code is authentic;
means, comprising a set of processor readable code, for providing at least one game of chance at the website page;
means, comprising a set of processor readable code, for allowing participants that input an authentic access code to play said at least one game a predetermined number of times; and
means, comprising a set of processor readable code, for communicating to the participant whether the participant won said at least one game.

20. A system as recited in claim 19, further comprising:
means for conveying at least one predetermined award to the participant if the participant wins said at least one game based on at least one predetermined parameter.

21. A system as recited in claim 20, wherein said award comprises a predetermined prize.

22. A system as recited in claim 20, wherein said award comprises a predetermined number of redemption points for potential ongoing accumulation and redemption points.

23. A system as recited in claim 19, further comprising:
means, comprising a set of processor readable code, for determining whether the participant won said at least one game based on predetermined parameters after the participant plays the game.

24. A process as recited in claim 19, wherein said game requires the participant to perform at least one computer processor readable action after entering said authentic code to play said game.

25. A process as recited in claim 19, wherein said step of determining code authenticity comprises:
means, comprising a set of processor readable code, for comparing a code entered to a predetermined valid code.

26. A process as recited in claim 19, wherein said step of determining code authenticity comprises:
means for forwarding the access code that participant entered at the website in its original version to a designated location.

27. A process as recited in claim 19, wherein said access code comprises a plurality of unique access codes.

28. A process as recited in claim 19, wherein said at least one game of chance comprises a plurality of games that each require at least one computer processor readable point-and-click action or computer key entry.

29. A process as recited in claim 19, wherein said game comprises an electronic game that requires actuation of at least one hot spot to randomly cycle a plurality of images wherein a predetermined number of said images must match to win.

30. A process as recited in claim 19, wherein said game comprises inputting a predetermined number of numbers in a predetermined range and actuating a hot spot to randomly cycle through the numbers in said range until it stops and requiring that a predetermined number said inputted numbers match a predetermined number combination.

31. A process as recited in claim 19, wherein said game comprises selecting a predetermined number of electronic playing cards and comparing the selected playing cards to a preselected combination of cards to determine winning or non-winning status.

32. A process as recited in claim 19, wherein said game comprises a plurality of random gift spots that require the actuation and matching of a predetermined number of hot sots to determine winning or non-winning status.

33. A process as recited in claim 19, wherein said game comprises actuating a predetermined number of hot spots which must result in a predetermined number of matches to win.

34. A process as recited in claim 19, wherein said game comprises an electronic generated wheel that spins when a corresponding hot spot is actuated and reveals whether the participant won when it stops.

35. A process as recited in claim 19, wherein said game comprises an electronic generated selection of identifiable hot spots that facilitates the selection of at least one of said hot spots to reveal a winning status.
